(19) United States
(12) Patent Application Publication
(10) Pub. No.: US 2013/0259587 A1
(43) Pub. Date: Oct. 3, 2013

(54) PROCESSING METHOD FOR VARIABLE DEPTH, DEEP-HOLE DRILLING, CHIP BREAKING AND REMOVAL

(71) Applicant: Changchun Railway Vehicles Co., Ltd., Changchun (CN)

(72) Inventor: NA MA, Changchun (CN)

(21) Appl. No.: 13/902,699

(22) Filed: May 24, 2013

Related U.S. Application Data
(63) Continuation of application No. PCT/CN2011/075253, filed on Jun. 3, 2011.

(30) Foreign Application Priority Data
Nov. 26, 2010 (CN) 201010561932.5

(51) Int. Cl. B23B 35/00

(52) U.S. Cl. CPC B23B 35/00
USPC 408/1 R

(57) ABSTRACT

A processing method for variable drilling-depth, deep-hole chip breaking and removal, comprising: assigning a deep-hole drilling variable value; if the value is correct, drilling a first hole depth; otherwise, alarming and reassigning the value; determining whether the first hole depth is greater than a terminal drilling depth and whether the first hole depth is greater than the defined chip breaking depth; if yes, processing chip breaking and drilling to the currently designated drilling depth and then returning to a safe position for chip removal; determining whether the currently designated drilling depth is greater than a smallest drilling depth, if yes, decreasing the drilling depth progressively according to a designated drilling depth proportion, otherwise, designating the currently designated drilling depth as a new smallest drilling depth and calculating the coordinate of the next drilling depth. Drilling deep hole in accordance with this method can improve efficiency and guarantee drilling safety.

### CROSS-REFERENCE TO RELATED APPLICATIONS

This application is a continuation of International Application No. PCT/CN2011/075253, filed on Jun. 3, 2011, which claims the priority benefit of China Patent Application No. 201010561932.5, filed on Nov. 26, 2010. The contents of the above identified applications are incorporated herein by reference in their entirety.

### FIELD OF THE TECHNOLOGY

The present invention relates to a deep-hole processing method with convenient chip removal.

### BACKGROUND

In frame processing, there are often deep holes having a length-diameter ratio of more than 1:5 even 1:10. These deep holes generally have small diameter of about 20 mm, such as the unit braking holes of various urban rail cars. Current deep-hole processing method adopts type G83 deep-hole circulation, in field processing, accidents like chip spooling, squeezing on the drill and broken of the drill often occur in deep-hole processing procedure. Processing the above deep holes became a real problem for the technologists, and the operator had to regularly stop during processing to manually remove the chips, which seriously affected the processing efficiency.

### SUMMARY

The objective of the present invention is to provide a variable depth deep-hole chip breaking and removal circulation, solves the problem of chip squeezing inside of the deep holes, extends the service life of a drill, and improves the processing efficiency.

In order to solve the above technical problem, the present invention provides a processing method for variable depth, deep-hole drilling, chip breaking and removal, characterized by comprising the following steps:

Step 102: designating a deep-hole drilling variable, and assigning a value to the variable involved in the deep-hole drilling procedure, if the value is correct, enter into step 103, if the value is not correct, enter into step 104 and reassign the value;

Step 103: drilling a first hole depth;

Step 105: determining whether the coordinate of the drilling depth is greater than that of a terminal drilling depth, if yes, enter into step 106, otherwise, enter into step 109 to complete the last drilling depth, and stop at step 110;

Step 106: determining whether the drilling depth is greater than a defined chip breaking depth, if yes, enter into step 107 for chip breaking; otherwise, enter into step 111;

Step 111: processing to the current designated drilling depth and returning to a safe position for chip removal;

Step 112: determining whether the current drilling depth is greater than the smallest drilling depth, if yes, enter into step 113; otherwise, enter into step 114 to designate the current drilled depth as the new smallest drilling depth, enter into step 108;

Step 113: decreasing the drilling depth progressively according to a designated drilling depth proportion, enter into step 108;

Step 108: calculating the coordinate of the next drilling depth, return to step 105 for determining.

When a deep hole is drilled in accordance with this method, the drilling depths of the deep hole are divided into a plurality of sections, and the actions of chip breaking and removal are combined in each section; chip breaking is carried out within a certain range of the drilling depth, and chip removal is carried out when the range is exceeded so as to maintain smooth removal of the iron chips at all times, thus improving efficiency and guaranteeing drilling safety.

### BRIEF DESCRIPTION OF THE DRAWINGS

FIG. 1 is a flowchart of the present invention.

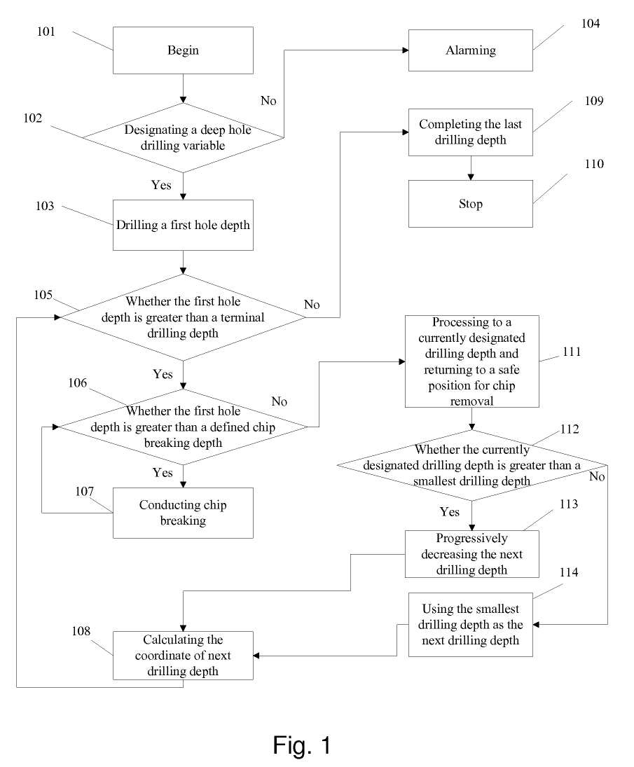

### DETAILED DESCRIPTION OF THE EMBODIMENTS

Referring to the drawing, step 102, values are assigned to the variables involved in deep-hole drilling, including safety height, feed speed, first drilling depth, drilling start position, drilling end position, progressively decreasing drilling depth proportion, and smallest drilling depth, and holes are drilled in accordance with the designated first drilling depth. The significance of designating the decreasing proportion of the drilling depth is: as the drilling depth increases, chip breaking is getting worse, it is beneficial to decrease the drilling depth properly for a smooth chip removal. The significance of designating a smallest drilling depth is: when the drilling depth is decreased to a certain value close to a chip breaking depth, further decreasing the drilling depth will be no longer beneficial to chip breaking, thus it is necessary to designate a smallest drilling depth value, when the value is reached, a constant drilling deep depth will be used for further drilling process.

Step 106, Determine whether the current designated drilling depth is greater than the defined chip breaking depth, if yes, chip breaking is conducted, otherwise, drill to the current designated drilling depth position and then return to a safe position for chip removal.

Step 112, Determine whether the current drilled depth is greater than the smallest drilling depth, if yes, decreasing the next drilling depth progressively according to a designated drilling depth proportion, otherwise, designating the current drilled depth as the new smallest drilling depth.

Step 108, Calculate the coordinate of the next drilling depth.

Step 105, Determine whether the coordinate of the current designated drilling depth is greater than that of a terminal drilling depth, if yes, enter into step 106 to determine and drill holes; otherwise, drill to the coordinate of the terminal drilling depth, and complete the whole deep-hole drilling process.

What is claimed is:

1. A processing method for variable depth, deep-hole drilling, chip breaking and removal, characterized by comprising the following steps:
Step 102: designating a deep-hole drilling variable, and assigning a value to the variable involved in the deep-hole drilling, if the value is correct, enter into step 103; if the value is not correct, enter into step 104 for alarming and reassigning the value;
Step 103: drilling a first hole depth;
Step 105: determining whether the first hole depth is greater than that of a terminal drilling depth, if yes, enter into step 106, otherwise, enter into step 109 to complete last drilling depth, and stop at step 110;
Step 106: determining whether the first hole depth is greater than a defined chip breaking depth, if yes, enter into step 107 for chip breaking; otherwise, enter into step 111;
Step 111: processing to a currently designated drilling depth and returning to a safe position for chip removal;
Step 112: determining whether the currently designated drilling depth is greater than a smallest drilling depth, if yes, enter into step 113; otherwise, enter into step 114 to designate the currently designated drilling depth as a new smallest drilling depth, enter into step 108;
Step 113: decreasing the drilling depth progressively according to a designated drilling depth proportion, enter into step 108;
Step 108: calculating the coordinate of next drilling depth, return to step 105 for determining.
